(19) United States
(12) Patent Application Publication
(10) Pub. No.: US 2007/0065190 A1
(43) Pub. Date: Mar. 22, 2007

(54) Heating device and fixing apparatus having the same

(75) Inventors: Dong-Jin Seol, Suwon-si (KR); Jae-Hyeuk Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/370,824

(22) Filed: Mar. 9, 2006

(30) Foreign Application Priority Data
Sep. 16, 2005 (KR) 2005-86871

(51) Int. Cl. G03G 15/20

(52) U.S. Cl. 399/328; 399/333

(57) ABSTRACT

A heating device suitable for use in an image forming apparatus and a fixing apparatus having the same. The heating device comprises heating roller having a double-layered structure of a magnetic layer and a non-magnetic layer; a heat generation unit installed on the inner peripheral surface of the heating roller; a first insulation layer for insulating the heating roller and the heat generation unit; an internal tube installed on the inner peripheral surface of the heat generation unit so that the heat generation unit can be tightly contacted with the heating roller; and a second insulation layer for insulating the heat generation unit and the internal tube. The heating device can make the temperature of the heating roller equalized and maximize the power efficiency because the heating roller has a double-layered structure of a magnetic layer and a non-magnetic layer and the heat generation unit is tightly contacted with the heating roller. The inventive fixing apparatus is provided with such a heating device.

### CROSS-REFERENCE TO RELATED APPLICATIONS

This application claims the benefit under 35 U.S.C. § 119(a) of Korean Patent Application No. 2005-86871 filed on Sep. 16, 2005 in the Korean Intellectual Property Office, the entire disclosure of which is hereby incorporated by reference.

### BACKGROUND OF THE INVENTION

1. Field of the Invention

The present invention relates to a heating device and fixing apparatus having the same. More particularly, the present invention relates to a heating device of an image forming apparatus, and a fixing apparatus having the same.

2. Description of the Related Art

In general, an image forming apparatus, such as a printer, a copy machine or the like, includes a fixing apparatus for fixing toner particles transferred to paper. The fixing apparatus is a means for fixing a toner image transferred to paper by applying heat and pressure. Until recently, conventional fixing apparatuses have employed halogen lamps for heating. Currently, fixing apparatuses employ a heating method using induction.

FIG. 1 shows a construction of a representative fixing apparatus employing an induction heating method. Referring to the drawing, a fixing apparatus typically includes a heating device 10 and a compressing device 20 arranged opposite to the heating device 10. The heating device 10 has a heating roller 11 in the form of a pipe and a heat generation unit 12 installed within the roller 11. The heat generation unit 12 comprises an induction coil 13 and a core 14. If alternating current is applied from a power supply (not shown) to the induction coil 13, magnetic fluxes are generated. The magnetic fluxes alternately pass the intermediate portion between the opposite ends 14a and 14b of the core 14. Subsequently, the heating roller 11 formed of a metallic material is positioned at an area where the magnetic fluxes pass. Therefore, because the magnetic fluxes alternately pass the heating roller 12, the heating roller 12 cuts the magnetic fluxes. This results in a variation of the magnetic fluxes and heat generated by the heating roller 12 due to an electromagnetic induction phenomenon. The compressing device 20 is located underneath the heating roller 11, which is heated as described above, with a paper S sandwiched between the compressing device 20 and the heating roller 11. Therefore, a toner image T formed on the paper S is melted and fixed on the paper S by a given pressure and heat while the paper S passes between the heating roller 11 and the compressing roller 20.

Japanese unexamined patent publication No. 2001-230064, the entire disclosure of which is incorporated herein by reference, discloses a representative fixing apparatus with a heating device that has an improved induction heating method over the above-mentioned conventional heating device. FIG. 2 shows the construction of the improved fixing apparatus.

The heating device 10a shown in FIG. 2 comprises a magnetic flux generation means 12 consisting of an induction coil 13, a core 14 and a heating roller 11. The heating roller 11 has an inner surface formed by a ferromagnetic material layer 11a to make contact with the magnetic flux generation means 12 and an outer surface formed by a high heat-conductive material layer 11b. An interface between the ferromagnetic material layer 11a and the high heat-conductive material layer 11b is unevenly formed. The heating device 10a makes it possible to uniformly increase the temperature in an area of the heating roller where the paper does not pass. The heating device is superior in power efficiency relative to the heating roller 11 of FIG. 1 because the ferromagnetic material layer 11a effectively generates heat in connection with input power and the temperature is evenly distributed over the heating roller 11 by the high heat-conductive material layer 11b. Even though the heating device employs the double layered structure of a ferromagnetic material layer and a high heat-conductive material layer to equalize the distribution of temperature, obtaining sufficiently high power efficiency is still impossible.

Accordingly, there is a need for an improved heating device capable of equalizing the distribution of temperature and obtaining sufficiently high power efficiency.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a heating device including a heating roller and a heat generation unit, in which the heating roller takes a double-layered structure of a magnetic layer and a non-magnetic layer. The heating unit is tightly contacted with the heating roller, so that the temperature is evenly distributed over the heating roller and power efficiency can be maximized.

In order to achieve the above-described aspects of exemplary embodiments of the present invention, a heating device is provided where, a heating roller has a double-layered structure of a magnetic layer and a non-magnetic layer; a heat generation unit is installed on the inner peripheral surface of the heating roller; a first insulation layer insulates the heating roller and the heat generation unit; an internal tube installed on the inner peripheral surface of the heat generation unit so that the heat generation unit can be tightly contacted with the heating roller; and a second insulation layer insulates the heat generation unit and the internal tube.

The heating roller of the double-layered structure may be fabricated by spray-coating a non-magnetic material on a surface of a pipe of magnetic material. The heating roller may also be fabricated by expanding a pipe of non-magnetic material and then fusion welding the pipe of non-magnetic material on a surface of a pipe of magnetic material. Alternatively, the heating roller may be fabricated using a metal sheet having a double-layered structure of a magnetic layer and a non-magnetic layer formed through a cladding process.

In the heating roller, it is possible for the magnetic layer to form the inner surface of the heating roller and for the non-magnetic layer to form the outer surface of the heating roller. To the contrary, it is also possible for the magnetic layer to form the outer surface of the heating roller and for the non-magnetic layer to form the inner surface of the heating roller.

Preferably, the non-magnetic layer may be embedded in the magnetic layer to be spaced from bearings installed at the opposite ends of the heating roller.

The heating roller may have a thickness in the range of 0.3 mm to 1.5 mm. Here, the thickness of the magnetic layer, which forms the double-layered structure with the non-magnetic layer, can be determined so that it shall not be less than a penetration depth defined by Equation 1 as follows: Δ=\sqrt{ρ}×107/2π\sqrt{μf}(m) (1) wherein Δ is a penetration depth of high frequency current, μ is relative permeability of a material, ρ is resistivity of the material [Ω·m], and f is frequency.

The heating unit may include: an induction coil wound to be tightly contacted with the inner peripheral surface of the heating roller and a power supply for applying power to the induction coil.

It is preferable that the internal tube is formed from a non-magnetic material and the internal tube is expanded from the inner side to the outer side of the heating roller.

A fixing apparatus according to an exemplary embodiment of the present invention comprises the afore-mentioned heating device and a compressing device installed opposite to the heating device.

Other objects, advantages, and salient features of the invention will become apparent to those skilled in the art from the following detailed description, which, taken in conjunction with the annexed drawings, disclose exemplary embodiments of the invention.

### BRIEF DESCRIPTION OF THE DRAWINGS

The above aspects and features of the present invention will be more apparent from the description for certain exemplary embodiments of the present invention taken with reference to the accompanying drawings, in which:

FIG. 1 is a constructional view of a conventional fixing apparatus of induction heating type;

FIG. 2 shows a constructional view of another conventional fixing apparatus of induction heating type;

FIG. 3 is a side cross-sectional view of a fixing apparatus according to an exemplary embodiment of the present invention;

FIG. 4 is a front cross-sectional view of a heating device according to an exemplary embodiment of the present invention;

FIG. 5 shows the construction of a portion indicated by “A” in the heating device of FIG. 4 in detail;

FIG. 6 shows the construction of a portion corresponding to the “A” portion in another heating device in detail;

FIG. 7A and FIG. 7B are views showing the flow of electromagnetic field, induced current and resistance heat in the heating device according to an exemplary embodiment of the present invention; and

FIG. 8 is a graph showing the distribution of current density and power density in relation to permeation depth.

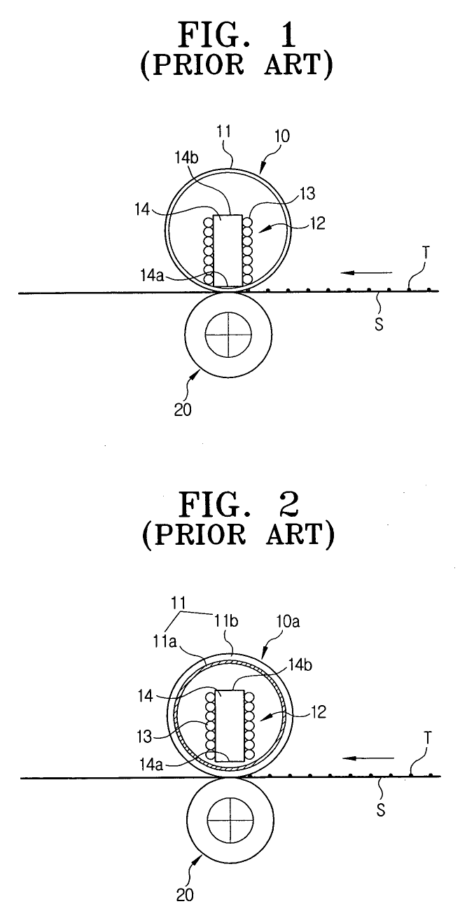

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

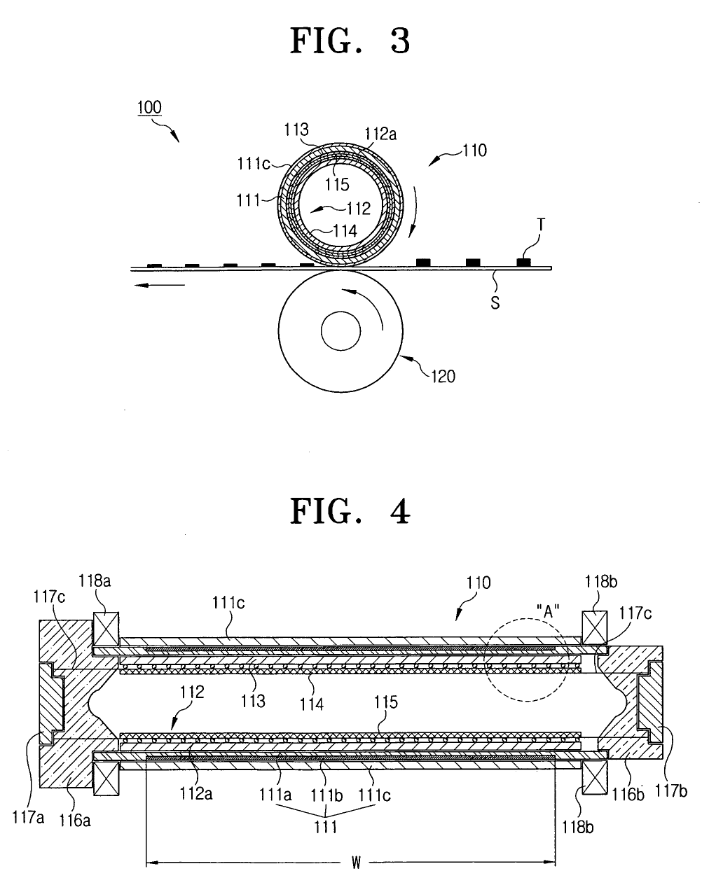

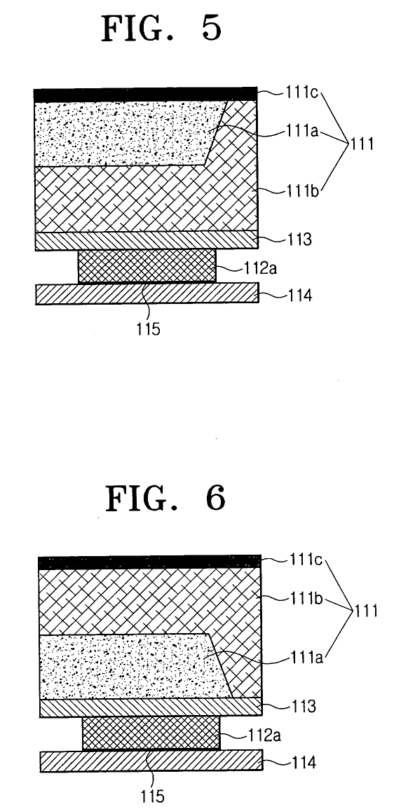

FIG. 3 is a side cross-sectional view of a fixing apparatus according to an exemplary embodiment of the present invention, FIG. 4 is a front cross-sectional view of a heating device according to the exemplary embodiment of the present invention, and FIG. 5 shows the construction of a portion indicated by “A” in the heating device of FIG. 4 in detail. In addition, FIG. 6 shows the construction of a portion corresponding to the “A” portion in another heating device in detail.

Referring to the drawings, a fixing apparatus 100 according to an exemplary embodiment of the present invention includes a heating device 110 and a compressing device 120 installed opposite to the heating device 110.

The heating device 110 includes a heating roller 111, a heat generation unit 112 and an internal tube 114.

The heating roller 111 is formed of a metallic material in the form of a pipe. It is preferable to form a release layer 111c on the external surface of the heating roller in order to prevent the attachment of toner particles. The release layer 111c is preferably formed from a Teflon™ coating, or a fluorine based layer such as Perfluoroalkoxy (PFA) and Polytetrafluoroethylene (PTFE).

According to an exemplary embodiment of the present invention, the heating roller has a double-layered structure including a magnetic layer 111a and a non-magnetic layer 111b. The magnetic layer 11a forms the outer surface of the heating roller 111 and the non-magnetic layer 111b forms the inner surface of the heating roller 111, as shown in FIG. 5. It is also possible for the magnetic layer 111a to form the inner surface of the heating roller 111 and for the non-magnetic layer 111b to form the outer surface of the heating roller 111, as shown in FIG. 6. In the former case, the heat generated by resistance has more influence on the heating roller, whereas in the latter case, the heat generated by induction has more influence on the heating roller.

It is advantageous that the non-magnetic layer 111b of the heating roller 111 is formed in a width so that the opposite ends of the non-magnetic layer 111b are spaced from the opposite ends of the heating roller 111 and, so that the opposite ends of the non-magnetic layer 111b are spaced from bearings 118a and 118b installed at the opposite ends of the heating roller 11. Preferably, the non-magnetic layer 111b may be formed in a width which allows paper S to pass. Therefore, it is preferable for the non-magnetic layer 111b to be embedded in the magnetic layer 111a.

The magnetic layer 111a of the heating roller 111 is preferably formed from at least one of nickel and steel, and the non-magnetic layer 111b is preferably formed from at least one of aluminum and copper.

The heating device 110 according to an exemplary embodiment of the present invention may be designed in such a manner that the heating roller 111 has a suitable thickness in consideration of the skin effect and penetration depth of induced current. In an exemplary embodiment of the present invention, it is preferable that the heating roller 111 has a thickness in the range of 0.3 mm to 1.5 mm. Here, the thickness of the magnetic layer, which forms the double-layered structure with the non-magnetic layer, may be determined in such a way that the thickness is not more than the penetration depth defined by Equation 1 above. This is because the thickness of the heating roller 111 is related to the penetration depth of induced current in a material. For example, when the heating roller 111 is designed to have a thickness of about 0.5 mm, the non-magnetic layer may be about 0.3 mm if the magnetic layer has a thickness of about 0.2 mm. The heating roller 111 with the double-layered structure as described above may be fabricated by various methods. For example, it is possible to fabricate such a heating roller by spray-coating particles of low-melting point aluminum on the inner or outer wall of a steel pipe. In this case, the steel pipe forms a magnetic layer, and then the coated surface is machined. It is also possible to fabricate a heating roller by preheating a thin-walled aluminum pipe to a temperature exceeding the melting point of the aluminum pipe to expand the diameter of the aluminum pipe, sticking the aluminum pipe fast to the inner or outer wall of the steel pipe, and then fusion-welding the aluminum pipe and the steel pipe together along the interface thereof. There is another method of fabricating a heating roller, in which a double-layered metallic sheet of a magnetic layer and a non-magnetic layer is prepared in advance through a cladding process and then the metallic sheet is formed into a pipe shape.

The heat generation unit 112 is positioned to be tightly contacted with the inner peripheral surface of the heating roller 111. It is desirable to form a first insulation layer 113 between the heating roller 111 and the heat generation unit 112. The heat generation unit 112 may include an induction coil 112a wound to be tightly contacted with the inner peripheral surface of the heating roller 111, and a power supply (not shown) for applying power to the induction coil 112a.

The induction coil 112a is axially arranged in such a manner that the outer peripheral surface of the induction coil 112a is tightly contacted with the inner peripheral surface of the heating roller 111. Such an induction coil may be formed from at least one of copper, a nickel-chrome alloy, an iron-chrome alloy and the like.

The power supply includes a transformer and a high frequency oscillation inverter for applying high frequency current to the induction coil 112a. The current supplied from the power supply is applied to the induction coil 112a through electrodes 117a and 117b and lead wires 117c provided in a pair of end caps 116a and 116b, which are fitted in the opposite ends of the heating roller 111.

The internal tube 114 is opened at its opposite ends and fitted in the induction coil 112a to make the induction coil 112a tightly contacted with the heating roller 111. It is preferable that the internal tube 114 is formed from a non-magnetic material, including at least one of stainless steel, aluminum, copper and a polymer. It is desirable to form a second insulation layer 115 between the heat generation unit 112 and the internal tube 114.

The first insulation layer 113 is interposed between the induction coil 112a and the heating roller 111. The second insulation layer 115 is interposed between the induction coil 112a and the internal tube 114. Accordingly, the induction coil 112a is spaced from the internal tube 114 by the thickness of the first insulation layer 113 and spaced from the heating roller 111 by the thickness of the second insulation layer 115. The first and second insulation layers 113 and 115 may be formed from a sheet-like insulation layer, including at least one of enamel, glass and a ceramic material such as magnesium oxide (Mao) or aluminum oxide (Al2O3). According to an exemplary embodiment of the present invention, it is preferable that the insulation layers have a thickness capable of providing at least an insulation function. Therefore, it is preferable to coat an insulation material to form a coated layer instead of attaching a sheet-like insulation material.

Meanwhile, the heating device 110 is fabricated through the following procedure. First, the second insulation layer 115 is provided to wrap the outer peripheral surface of the internal tube 114. The induction coil 112a is provided to wrap the second insulation layer 115. Then, the first coil 113 is provided to wrap the induction coil 112a. The induction coil 112a wrapped by the first insulation layer 113 and the internal tube 114 provided with the second insulation layer 115 as described above are inserted into the heating roller 111, the outer peripheral surface of which is coated with the release layer 111c. Then, the opposite ends of the internal tube 114 are closed by an apparatus for expanding the tube, and a predetermined level of pressure is applied to the inner space formed in the internal tube 114, thereby expanding the internal tube 114. Preferably, the pressure is not lower than 140 tam. The internal tube 114 is expanded, the heating roller 111 retains its circular shape, and the induction coil 112a, the internal tube 114, the first insulation layer 113 and the second insulation layer 115 are compressed against and in close contact with the inner peripheral surface of the heating roller 111. The gaps formed between the turns of the induction coil 112a are completely filled up with the first insulation layer 113 and the second insulation layer 115 when the internal tube 114 is expanded.

The heating device 110 having the above-mentioned double-layered structure can maximally exhibit heating effect and power efficiency by two heat-generating mechanisms. Heating effect and power efficiency are exhibited by making the thickness of the first and second insulation layers 113 and 115 as thin as possible, while making the heating roller 111 and the induction coil 112a of the heat generation unit as well as the internal tube 114 and the induction coil 112a maximally tightly contacted with each other at their interfaces through compressive pressure produced by the expansion of the internal tube 114.

The acting effects of the heating device configured as described above are now described with reference to accompanying drawings.

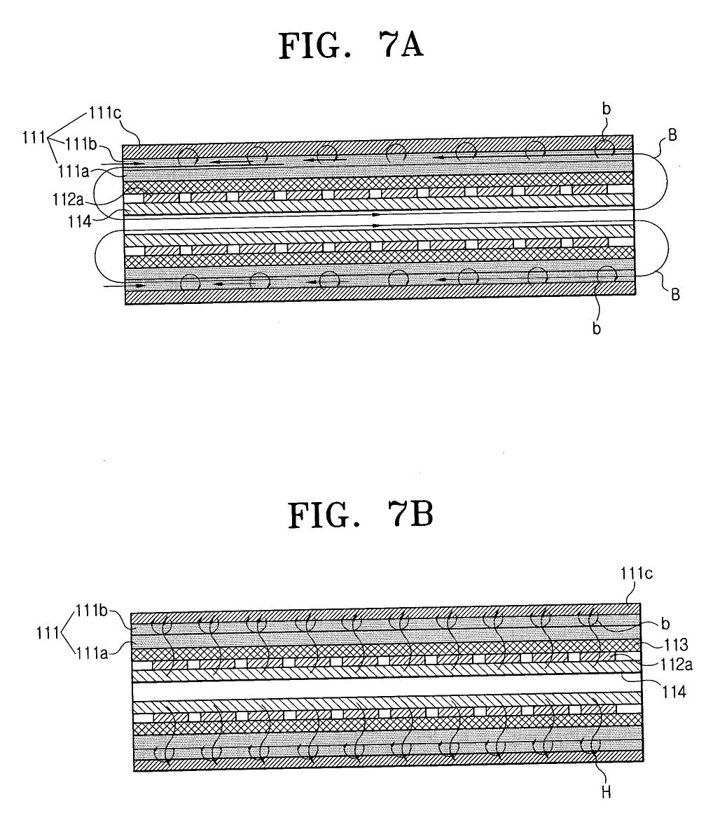

FIG. 7 shows the flow of magnetic field, induced current and heat in the heating device. FIG. 7A shows the flow of magnetic field and induced current and FIG. 7B shows the flow of induced current and resistance heat. The double-layered structure of the heating roller 111 of FIG. 7 corresponds to that of the heating roller 111 shown in FIG. 5, in which the outer side is a non-magnetic layer and the inner side is a magnetic layer.

According to the heating device of the above-mentioned exemplary embodiment, because the heating roller 111 has a double-layered structure of a magnetic and a non-magnetic material and the heat generation unit 112 is tightly contacted with the heating roller 111, unlike a conventional heating device of induction heating type, the heating roller is heated through two heat generation mechanisms, such as an induced heat generation mechanism and a resistance heat generation mechanism.

Referring to FIG. 4, if high frequency alternating current supplied from a power supply (not shown) is applied to the induction coil 112a through the electrodes 117a and 117b and lead wires 117c provided at the opposite ends of the heating device 110, a magnetic field B is generated around the induction coil 112a as shown in FIG. 7A. At this time, an eddy current b is generated in the magnetic heating roller by the counter electromotive forces for canceling the magnetic field, and Joule heat is generated in the heating roller 111 by the eddy current.

Along with the induced heat, the current flowing in the induction coil generates the Joule heat H by resistance load of the coil itself. The Joule heat H generated by the resistance load is thermally transferred to the first insulation layer 113 as shown in FIG. 7B, whereby the Joule heat H can be used in heating the heating roller 111 along with the induced heat.

Meanwhile, the eddy current b induced in the heating roller 111 by the induction coil 112a does not evenly flow in each cross-section of the heating roller but concentrates in the surface of the heating roller, wherein the eddy current b is exponentially reduced as the penetration depth is increased. For example, assuming the depth, at which the value of the current is equal to 1/ε (ε is about 2.718) of the maximum value of current in the surface, is the penetration depth Δ of high frequency current, the relative permeability of a material is μ, the resistivity (intrinsic resistance) of the material is ρ[Ω·m], and frequency is f, the penetration depth Δ of high frequency current is defined by Equation 1 as follows:
Δ=\sqrt{ρ}×107/2π\sqrt{μf}[mm] (1)

The above-mentioned phenomenon is called a surface effect of current, which is one of the characteristics of high frequency induction heating.

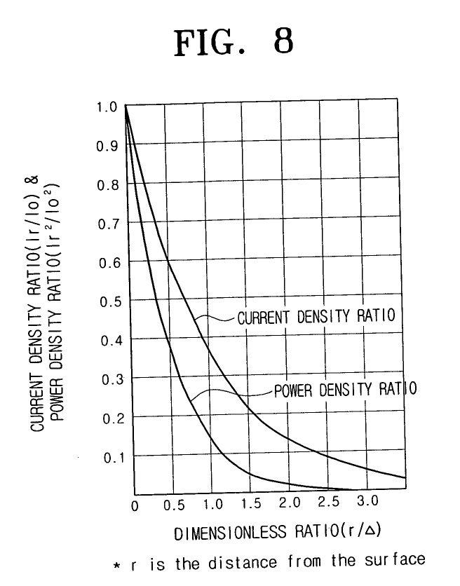

FIG. 8 is a graph showing the above-mentioned phenomenon, in which the distribution of current density and power density are indicated with reference to penetration depth. Since approximately 90% of heat is generated in the area from the surface to a penetration depth of a material, high frequency current is considered to concentrate in the area from the surface to the penetration depth. Therefore, when a specific material is used to determine the thickness of a heating roller, it is possible to calculate the penetration depth of the material according to the frequency from Equation 1 above. For example, in the case of α-iron, which is a representative metal for use in induction heating, Δ=16/√f [mm] because ρ=10 (μΩ·cm) and μ=100, and in the case of γ-iron, Δ=500/√f [mm] because ρ=100 (μΩ·cm) and μ=1. In the case of copper, Δ=65/√f [mm] because ρ=1.7 (μΩ·cm) and μ=1.

Table 1 shows penetration depths for respective frequencies in a carbon steel (STKM) pipe for use in the heating roller.

TABLE 1

| | Frequency | | | | | | |
|---|---|---|---|---|---|---|---|
| | 50 | 500 | 1 | 10 | 100 | 250 | 400 |
| | Hz | Hz | kHz | kHz | kHz | kHz | kHz |
| Penetration | 2.3 | 0.8 | 0.6 | 0.2 | 0.15 | 0.10 | 0.03 |
| Depth (mm) | | | | | | | |

In practice, a fixing apparatus typically uses a frequency in the range of 100 to 250 kHz in an image forming apparatus. Accordingly, it is possible to calculate the penetration depth at a certain penetration depth with reference to Table 1. For example, when steel is used for the magnetic layer and aluminum or copper is used for the non-magnetic layer, assuming that the entire thickness of the heating roller is about 0.5 mm, it is possible to obtain a sufficient heat generation effect from induction heating if the thickness of the magnetic layer is about 0.2 mm and the thickness of the non-magnetic layer is about 0.3 mm. According to an exemplary embodiment of the present invention, it is possible to reduce the thickness of the heating roller by making the induction coil tightly contact the heating roller while using a double-layered structure of a magnetic layer and a non-magnetic layer for the heating roller. Consequently, in the heating device 110 according to an exemplary embodiment of the present invention, the heat can be variously generated from the heat generation unit 112 and can be transferred, so that the surface of the heating roller 111 can be heated within a short time, thereby instantly arriving at the preferred fixing temperature.

As described above, according to an exemplary embodiment of the present invention, an induction coil is arranged to be in tight contact with the inner surface of a heating roller in a heating device, which is a member to be heated. The induction coil rotates along with the heating roller and the electric field generated by the induction coil can be maximally attenuated in the heated member, whereby the efficiency of induction heat generation can be maximized and the Joule heat generated by the resistance load of the induction coil itself can be used to a maximal degree, and the surface of the heating roller can be rapidly heated to a preferred temperature.

According to an exemplary embodiment of the present invention, by using a double-layered structure of a magnetic layer for generating induction heat and a non-magnetic layer of high heat conductivity for a heating roller in a heating device, it is possible to obtain an axially evenly distributed temperature while maintaining the efficiency of induction heating.

Since most of the induced heat is generated within a shallow depth from the surface of a heating roller in a heating device due to the skin effect, according to an exemplary embodiment of the present invention, it is possible to design the heating roller thin enough so that the surface of the heating roller can be rapidly heated to a preferred temperature.

Although representative exemplary embodiments of the present invention have been shown and described in order to exemplify the principles of the present invention, the present invention is not limited to the specific embodiments. It will be understood that various modifications and changes can be made by one skilled in the art without departing from the spirit and scope of the invention as defined by the appended claims.

What is claimed is:

1. A heating device comprising:
a heating roller comprising a double-layered structure of a magnetic layer and a non-magnetic layer;
a heat generation unit installed on the inner peripheral surface of the heating roller;
a first insulation layer for insulating the heating roller and the heat generation unit;
an internal tube installed on the inner peripheral surface of the heat generation unit whereby the heat generation unit can be tightly contacted with the heating roller; and
a second insulation layer for insulating the heat generation unit and the internal tube.

2. A heating device as claimed in claim 1, wherein the heating roller is fabricated by spray-coating a non-magnetic material on a surface of a pipe of magnetic material.

3. A heating device as claimed in claim 1, wherein the heating roller is fabricated by expanding a pipe of non-magnetic material and then fusion welding the pipe of non-magnetic material on a surface of the pipe of magnetic material.

4. A heating device as claimed in claim 1, wherein the heating roller is fabricated using a metal sheet having a double-layered structure of a magnetic layer and a non-magnetic layer and formed through a cladding process.

5. A heating device as claimed in claim 1, wherein the magnetic layer forms the inner surface of the heating roller and the non-magnetic layer forms the outer surface of the heating roller.

6. A heating device as claimed in claim 1, wherein the magnetic layer forms the outer surface of the heating roller and the non-magnetic layer forms the inner surface of the heating roller.

7. A heating device as claimed in claim 1, wherein the non-magnetic layer is embedded in the magnetic layer to be spaced from bearings installed at the opposite ends of the heating roller.

8. A heating device as claimed in claim 1, wherein the heating roller has a thickness in the range of 0.3 mm to 1.5 mm.

9. A heating device as claimed in claim 1, wherein the thickness of the magnetic layer which forms the double-layered structure with the non-magnetic layer is determined to be at least a penetration depth defined by following equation:
Δ=\sqrt{ρ}×107/2π\sqrt{μf}(m)
wherein Δ is a penetration depth of high frequency current, μ is relative permeability of a material, ρ is resistivity of the material [Ω·m], and f is frequency.

10. A heating device as claimed in claim 1, wherein the heating roller is coated with a release layer on its outer surface.

11. A heating device as claimed in claim 1, wherein the heating unit comprises:
an induction coil wound to be tightly contacted with the inner peripheral surface of the heating roller; and
a power supply for applying power to the induction coil.

12. A heating device as claimed in claim 1, wherein the internal tube is expanded in the inner side of the heating roller toward the outer side of the heating roller.

13. A heating device as claimed in claim 12, wherein the internal tube is formed from a non-magnetic material.

14. A fixing apparatus comprising:
a heating device; and
a compressing device installed opposite to the heating device, wherein the heating device comprises:
a heating roller having a double-layered structure of a magnetic layer and a non-magnetic layer;
a heat generation unit installed on the inner peripheral surface of the heating roller;
a first insulation layer for insulating the heating roller and the heat generation unit;
an internal tube installed on the inner peripheral surface of the heat generation unit whereby the heat generation unit can be tightly contacted with the heating roller; and
a second insulation layer for insulating the heat generation unit and the internal tube.
